(19) United States
(12) Patent Application Publication
(10) Pub. No.: US 2006/0011708 A1
(43) Pub. Date: Jan. 19, 2006

(54) Friction plug welding method, for a hole in a metal part, use of a metal bar and of a bearing supporting part for implementing the method

(75) Inventors: Bernard Bouet, Gretz Armainvilliers (FR); Jean-Pierre Ferte, Corbeil Essonnes (FR); Olivier Gourbesville, La Celle St Cloud (FR); Didier Bruno Le Saunier, Torcy (FR)

Correspondence Address: OBLON, SPIVAK, MCCLELLAND, MAIER & NEUSTADT, P.C., 1940 DUKE STREET, ALEXANDRIA, VA, 22314, US

(73) Assignees: SNECMA MOTEURS, Paris (FR); SNECMA SERVICES, Paris (FR)

(21) Appl. No.: 11/113,109

(22) Filed: Apr. 25, 2005

(30) Foreign Application Priority Data
Apr. 27, 2004 (FR) 0404430

(51) Int. Cl. B23K 20/12

(52) U.S. Cl. 228/112.1

(57) ABSTRACT

The invention concerns a friction plug welding method, for a hole, extending globally along an axis, in a metal part, failing any clearance space in the axis of the hole, because of at least one obstacle on said axis, wherein a metal bar, extending globally along an axis, is rotated around its axis and is inserted into the hole, to be friction welded therein. The method of the invention is characterised in that the axis if the bar is tilted with respect to the axis of the hole of a non-zero angle (α) to avoid the obstacle. Thus, thanks to the method of the invention, it is possible to reach holes difficult of access, while orienting the axis of the bar suitably.

The invention relates to a friction plug welding method, for a hole in a metal part.

Friction plug welding is used for plugging holes in a metal part, generally circular holes emerging from both sides of the part, truncated or cylindrical in shape. This method is used when it is desired to limit the loss of mechanical characteristics, with respect to the mechanical characteristics of the original part, in the plugging area of the hole.

A metal bar, generally of the same nature as the material forming the part, is rotated and inserted, under the action of a driven force, into the hole to be plugged, the part containing the latter remaining fixed, perpendicular to the surface of the part in the hole area.

The frictions between the bar and the wall of the hole of the part cause heating of both materials, plasticizing then welding thereof into solid phase. Two pads are formed on each side of the part. It then suffices to machine the bar and the pads on each side of the part to retrieve the part in its original shape, with its hole plugged.

Thanks to the friction plug welding method, it is for example possible to repair flange holes of a turbojet engine, which have become out of round: the out-of-round holes, after correct machining, are plugged thanks to the method, then re-drilled to a correct shape.

However, because of the shape of the various housings of a turbojet engine and of the distribution of the flanges at the surface thereof, certain flanges are not accessible for the metal bar within the framework of the method. Indeed, this bar, connected to its driving machine, should be oriented perpendicular to the surface of the flange; it may not therefore allow implementation of the method, failing sufficient clearance space in the axis of the hole, for example further to obstacles placed on said axis, such as other flanges. Thus, certain holes may not be plugged using the friction plug welding method because of accessibility problems.

To remedy this shortcoming, these flange holes may be plugged using a machine metal plug, keyed in place, but it is almost impossible to be re-drilled.

A bevel gear mechanism might also be developed for the metal bar, but such a mechanism is expensive.

It may also be contemplated to develop a miniaturised friction plug welding machine, but such a development and the implementation of such a machine are also very expensive.

It is also therefore little practical or expensive to implement a friction plug welding method on flanges away from the location of the machine supporting the welding bar.

The present invention provides a friction plug welding method enabling to reach hardly accessible elements.

In this view, the invention concerns a friction plug welding method, for a hole, extending globally along an axis, in a metal part, failing any clearance space in the axis of the hole, because of at least one obstacle on said axis, wherein a metal bar, extending globally along an axis, is rotated around its axis and is inserted into the hole, to be friction welded, characterised in that the axis of the bar is tilted with respect to the axis of the hole by a non-zero angle to avoid the obstacle.

Thanks to the method of the invention, it is possible to avoid obstacles, disturbing the implementation of a hole friction plug welding process, while orienting the bar correctly with respect to the hole and to the obstacles.

The applicant has discovered that, preferably, the angle between the axis of the bar and the axis of the hole should be smaller than or equal to 11°.

Advantageously, the bar comprises a welding head of minimum sizes to provide friction welding, and a stiff bar of diameter smaller than or equal to that of the head and supporting the head.

Advantageously still, the bar is supported, at one end, by a driving machine, by at least one point between both its ends, by an intermediate bearing.

The invention relates particularly to a friction plug welding method, for a hole in a flange, of aluminium alloy, of a turbojet engine housing, but the applicant does not intend to limit the extent of its rights to that sole application.

The invention concerns moreover the use of a metal bar, for implementing the method aforementioned, the bar comprising a welding head and a stiff bar welding head of diameter smaller than the diameter of the head.

The invention also concerns the use of a bearing supporting part, for implementing the method described above, the part including an intermediate bearing for a welding bar.

The invention will be understood better using the following description of the preferred embodiment of the method according to the invention, with reference to the appended drawings, wherein:

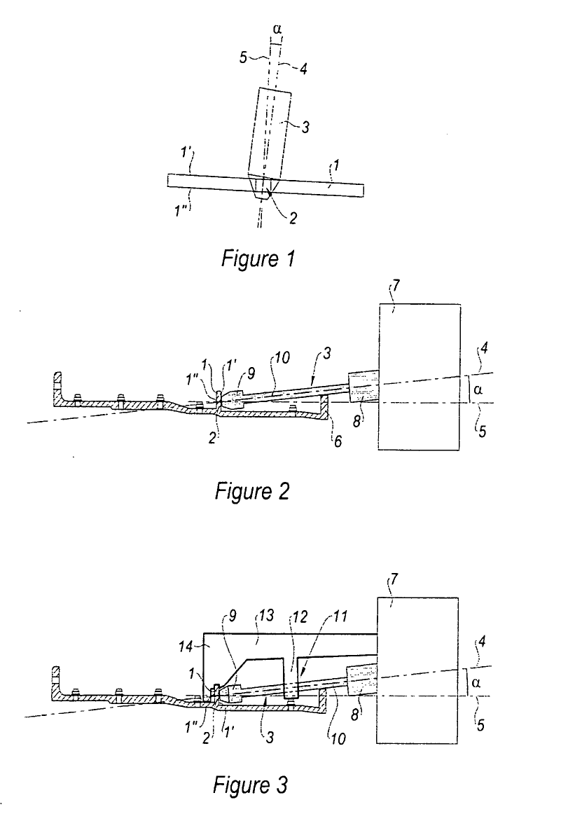

FIG. 1 represents a schematic section view of the implementation of the friction plug welding method of a hole according to the preferred embodiment of the method of the invention;

FIG. 2 represents a schematic section view of the implementation of the friction plug welding method of a hole in a flange of a turbojet engine according to a first embodiment of the method of the invention, and

FIG. 3 represents a schematic section view of the implementation of the friction plug welding method of a hole in a flange of a turbojet engine according to a second embodiment of the method of the invention.

The method if the invention applies to a metal part, here a flange in a turbojet engine 1 made of aluminium alloy, wherein a hole 2 is to be plugged. In this view, a hole, which has become out of round, on a flange 2 is to be plugged, while keeping mechanical properties close to those of the basic material, in order to be re-drilled, once plugged, to adopt a correct shape. To that effect, a hole friction plug welding method is used.

Generally, the degraded hole, here out of round, has been machined previously, in order to confer a cylindrical or truncated shape thereto. This new hole, here the hole 2 that is to be plugged, extends generally along an axis perpendicular to the surface of the part, preferably along the same axis along which the original hole extended. Thus, the whole degraded surface of the hole is eliminated, to render it cylindrical or truncated, while minimising the volume of matter removed.

The hole 2 is here cylindrical in shape. It emerges onto a first face of the flange 1, which will be considered as the front face 1′ of the flange 1, and onto a second face of the flange 1, opposite to the front face 1′, which will be therefore considered as the back face 1″ of the flange 1.

In the friction plug welding method, a metal bar 3, here made of aluminium alloy, extending along an axis 4, is rotated around its axis 4 and is friction welded, under the action of a driven force, in solid phase, to the flange 1. The metal bar 3 comprises here an end portion, truncated in shape, suited to the sizes of the hole 2 and to the operating parameters of those skilled in the art. Its end portion could also be, as the case may be, cylindrical in shape.

The friction plug welding method of the invention differs from the methods of the previous art in that the bar 3 is welded to the flange 1 along an axis 4 tilted with respect to the axis 5 of the hole 2.

Indeed, in the methods of the previous art, the bar 3 is systematically welded to the part 1, here the flange 1, in the axis 5 of the hole 2, i.e. that axis 4 of the bar 3 is confused with the axis 5 of the hole 2. The hole 2 being often drilled perpendicular to the surface of the part 1, the bar 3 should extend perpendicular to the surface of the part 1, which causes certain shortcomings mentioned above. Conversely, the method of the invention suggest to choose an angle a between the axis 4 of the bar 3 and the axis 5 of the hole 2, which allows greater flexibility regarding access of the bar 3 to the hole 2, enabling to avoid certain obstacles.

The method of the invention may be implemented, like conventional friction welding methods of the previous art, according to various operating modes, in particular according to a so-called ‘driven friction’ mode or a so-called ‘inertial friction’ mode.

In both modes, a first stage consists, under pre-set pressure, in contacting the bar 3 and the wall of the hole 2 in order to determine the exact position of the contact between both, the flange remaining fixed throughout the method. The bar 3 is moved accordingly, along its axis 4, towards the surface of the flange 1, on the front face 1′ side of the flange 1. Thus, here, the portion of the bar 3 with the smallest diameter is inserted through the front portion of the hole 2, then the bar 3 is moved until the truncated surface of the bar 3 touches a wall portion of the hole 2. Once the contact position has been determined, the bar 3 is brought to its starting position, i.e. a few millimetres recessed from the wall of the hole 2 of the flange 1.

In the case of the ‘driven friction’ mode, the bar 3, driven into rotation on its axis 4, and the wall of the hole 2 are contacted and heated mutually by friction, under the action also of a force applied to the bar 3, along its axis 4, towards the flange 1. After a certain heating-up time, determined by those skilled in the art, an additional axial force is applied, while the rotation is slowed down. The rotation of the bar 3 is decelerated until it stops, typically within 0.2 to 0.8 second and depends on the deceleration ability of the driving machine of the bar 3. Friction welding is then performed, while the axial force applied is maintained after the rotation of bar 3 has stopped, to ensure good welding quality.

In the case of ‘inertial friction’, the bar 3 is placed similarly in starting position and driven into rotation. When it is brought into contact rotation, its rotational driving motor is declutched, so that the energy stored in the rotating system, via the rotational speed and the inertia wheel of the motor, which has been set and sized previously, is dissipated in the welding as in the ‘driven friction’ mode.

The operating modes described above are well known to those skilled in the art and will not be described further. They have been given only for illustrative purposes to facilitate the understanding of the invention, but are not limitative of the operating mode chosen for hole friction plug welding according to the invention. There exist other operating modes which might be implemented for the method of the invention.

Regardless of the operating mode selected, the man skilled in the art will adapt it to the method of the invention, with the angle a existing between the axis 4 of the bar and the axis 5 of the hole 2, and will select the appropriate operating parameters, for example empirically.

For illustrative purposes, tests conducted by the applicant have shown that, when plugging a cylindrical hole of 10 mm in diameter and 6 mm in height, i.e. a hole drilled into a flange of 6 mm in thickness, the angle a may not exceed 11°, failing which nicks are most likely to develop in the welding area.

Generally, by not exceeding an angle α of 10°, it is widely possible to perform the friction plug welding method with a tilted bar without any major problems.

With reference to FIG. 2, the friction plug welding method with a tilted bar enables to plug a hole 2 in the flange 1 of a turbojet engine housing which cannot be accessed using the methods of the previous art. Thus, on FIG. 2, it can be seen that the axis 5 of the hole 2 in the flange 1, on the front side 1′, extends another flange 6, which does not enable a bar 3 to extend perpendicular to the flange 1 while being connected to its driving machine 7. One therefore selects to tilt the bar 3 with respect to the axis 5 of the hole 2 according to an angle α, in the direction opposite to the surface of the housing, which enables the bar 3 to clear above the flange 6 creating an obstacle, because of the reach between the welding end of the bar 3 and the clamping jaws 8 connecting said bar to the driving machine 7.

To enable the bar 3 to reach holes which are even more difficult to access, it is possible, still in relation to FIG. 2, where the sizes are not true to scale, for easier understanding, to use a bar 3 especially designed for the method of the invention. By welding head 9, or head 9, is meant below the welding portion of the bar 3, i.e. the portion of the bar which will be friction welded to the wall of the hoe 2 to be plugged.

In the preferred embodiment of the invention, to improve the access capacity thereof, the bar 3 includes a head 9 of minimal sizes to conduct welding, i.e. whereof the sizes are just equal to or hardly greater than the sizes necessary to plugging the hole 2. The bar 3 further includes, in order to support, to place and to drive into rotation the head 9, a stiff rod 10, of diameter smaller than that of the head 9, in order to occupy less space, and with a possibly different matter.

The bar 3 of the invention includes here a head 9, of minimal sizes, of aluminium alloy, supported by a stiff rod 10 made of steel. The space requirements of the head 9 being minimised, the latter may reach points which are more difficult of access, while the rod 10 of small diameter allows to avoid bigger obstacles, for a same angle α, than with a greater diameter.

Still, in order to access certain flange holes, it is necessary to have a bar 3 of relatively large axial size. The distance between the head 9 of the bar 3 and the clamping jaws 8 of its other end being then rather large, vibrations can be noticed at the head 9, which are detrimental to any correct welding. With reference to FIG. 3, a second embodiment of the method of the invention is represented, which enables to reduce vibrations at the head of the bar 3.

In this method, a bar 3 is used in the same way as previously, comprising possibly a head 9 made of aluminium, as well as a stiff rod 10 made of steel, of smaller diameter, to plug a hole 2 in a flange 1, as the bar is brought into rotation by a driving machine 7, to which it is connected by jaws 8, around an axis 4. Friction plug welding is conducted with the bar 3 forming an angle a with the axis 5 of the hole 2.

This method differs from the previous one by the use of an intermediate bearing 11. This bearing 11 is situated in a bearing supporting part 12, comprising either a bore for letting through the rod 10, or a bearing for the rod 10, serving as a bearing 11 for the bar 3, in a point defined on the bar 3, for example in the middle of the bar 3, between the clamping jaws 8 and the head 9 of the bar 3. Preferably, it will be a roller bearing 11.

The bearing supporting part 12, may be interconnected, indifferently, to the part wherein a hole 2 is to be plugged, to the mechanism 7 driving the bar 3 into rotation or an independent tooling. On FIG. 3, the bearing supporting part 12 is interconnected with the driving machine 7, thanks to a beam 13 supporting said mechanism. The beam 13 is interconnected with the mechanism 7 and extends perpendicular to the mechanism, globally parallel to the part 1 to be plugged.

In this embodiment, the beam 13 also comprises, at its end opposite to the mechanism 7, a part 14 for resting on the part to be plugged. This part 14 is here sized in order to rest, on the one hand, on the flange 1, on the other hand, on a portion of the surface of the housing supporting the flange. Thus, the beam 13, its resting end part 14 and its bearing supporting part 12 are sized in a set fashion for plugging a hole in a particular type of flange.

It may also be contemplated to use a bearing supporting part 12 for the bar 4 which is quite modular relative to the use of the bar 3.

Anyway, the bearing supporting part 12 enables to support the bar 3, here at its stiff steel rod 10, while allowing the rotation thereof around its axis 4. This support reduces the vibrations caused by the rotation at the head 9 thereof, since it diminishes the lever arm to which the head 9 is subjected. Several supporting parts 12 could be used for a same bar.

The angle α between the axis 4 of the welding bar 3 and the axis 5 of the hole 2 to be plugged is adjustable thanks to a mechanism suited to the driving machine 7, or fixed for a machine dedicated to plugging a set type of hole. In case when it would be adjustable and when an intermediate bearing 11 would be provided, the bearing supporting part 12 would also be adjustable to suit the adjustment of the angle α.

The hole 2 may emerge on each side of the part, here the flange 1, or emerge on one side only.

The method has been described in relation to a hole extending along an axis perpendicular to the surface of the part. The hole may also be machined in order to extend along an axis forming a non-zero angle with axis perpendicular to the surface of the part, the method being implemented similarly, while taking as a reference for the angle α the axis of the hole.

The method of the invention has been described in relation to a part to be plugged, made of aluminium alloy, but it goes without saying that it applies to any type of alloy, in particular nickel, titanium or iron alloys. It has been described moreover in relation to a bar including a bar head of similar nature to the part to be plugged, but a head of different nature may be used.

1- A friction plug welding method, for a hole, extending globally along an axis, in a metal part, failing any clearance space in the axis of the hole, because of at least one obstacle on said axis, wherein a metal bar, extending globally along an axis, is rotated around its axis and is inserted into the hole, to be friction welded, characterised in that the axis of the bar is tilted with respect to the axis of the hole by a non-zero angle (α) to avoid the obstacle.

2- A method according to claim 1, wherein the angle (α) between the axis of the bar and the axis of the hole is smaller than or equal to 11°.

3- A method according to claim 1, wherein the bar comprises a welding head of minimum sizes to provide friction welding, and a stiff bar of diameter smaller than that of the head and supporting the head.

4- A method according to claim 1, wherein the bar is supported, at one end, by a driving machine, by at least one point between both its ends, by an intermediate bearing.

5- A method according to claim 1, wherein the part is a flange, made of aluminium alloy, of a turbojet engine housing.

6- A method according to claim 3, wherein the bar includes a head made of aluminium alloy and a stiff rod made of steel.

7- A use of a metal bar for implementing a friction plug welding method for a hole according to claim 1, the bar comprising a welding head and a stiff bar of diameter smaller than that of the head.

8- A use of a bar according to claim 7, wherein the head of the bar includes an aluminium alloy and the stiff rod of the bar includes steel.

9- A use of a bearing supporting part for implementing the friction plug welding method for a hole according to claim 5, wherein the part comprises an intermediate bearing for a welding bar.

10- A use of a part according to claim 9, wherein the intermediate bearing is a roller bearing.
